(19) United States
(12) Patent Application Publication
(10) Pub. No.: US 2006/0090330 A1
(43) Pub. Date: May 4, 2006

(54) Cooling plate module for a fuel cell stack

(75) Inventors: Pertti Kauranen, Tampere (FI); Alwin Muller, Wurzburg (DE)

Correspondence Address: LERNER GREENBERG STEMER LLP, P O BOX 2480, HOLLYWOOD, FL, 33022-2480, US

(73) Assignee: SGL Carbon AG

(21) Appl. No.: 11/261,057

(22) Filed: Oct. 28, 2005

(30) Foreign Application Priority Data
Oct. 29, 2004 (EP) 04 025 726.3

(51) Int. Cl. H01M 8/04; H01M 2/02; H01M 6/00

(52) U.S. Cl. 29/623.4; 429/34; 429/26

(57) ABSTRACT

A cooling plate module for fuel cell stacks contains an anode-side terminal plate and a cathode-side terminal plate, whose mutually facing surfaces functioning as cooling surfaces tightly enclose a coolant distribution structure and are joined to one another by a bonding agent. The bonding agent is applied to the cooling surfaces exclusively outside the coolant distribution structure surrounded by a seal, so that the bonding agent and coolant do not contact one another. Since the current transport between the terminal plates takes place principally via contact elements disposed in the coolant structure, it is not necessary for the bonding agent to be electrically conducting.

### BACKGROUND OF THE INVENTION

### Field of the Invention

The present invention relates to a module formed of two terminal plates joined to one another for a fuel cell stack, in which the two terminal plates tightly enclose a coolant distribution structure.

Fuel cells are devices for the direct conversion of chemical energy into electrical energy. An individual fuel cell 1 (FIG. 1) contains two electrodes, namely an anode 2 and cathode 3, with an interposed electrolyte layer, e.g. a proton-conducting membrane 4. This composite structure is termed a membrane-electrode assembly (MEA) 5. The oxidation of a fuel, e.g. hydrogen or methanol, takes place at the anode 2 with the release of protons and electrons. The released electrons flow through an outer electrical circuit, in which they perform electrical work, to the cathode 3. The released protons are transported through the membrane 4 to the cathode 3. Here an oxidizing agent, for example oxygen, is reduced by the uptake of the electrons and protons. The interfaces between the anode 2 and cathode 3, respectively, and electrolyte 4 are coated with catalysts 6 that accelerate the respective electrode reaction.

For practical applications a plurality of fuel cells are generally combined in a stack bounded by end plates, in order to achieve the required output. Current collectors are provided before the first cell and after the last cell. The stacked cells are pressed against one another and clamped by longitudinal bolts, clamping devices or other suitable methods (not shown in FIG. 1). Normally the cells in the stack are connected electrically in series, but in parallel with respect to a media flow. Bipolar (twin terminal) plates (BPP) 7, 7′ form the electrical contact between the adjacent cells. The successive BPP 7 and MEA 5 have aligned through-holes for a fuel supply 8 and fuel removal 9 as well as for an oxidizing agent supply 10 and oxidizing agent removal 11. These aligned through-holes form distribution and collection lines (manifolds), which pass through the stack in the stacking direction and supply the reaction media to and remove the reaction media from the individual cells.

The supply of the individual electrodes with the reaction media takes place via distribution structures incorporated into the surfaces of the BPP 7. The distribution structures contain suitably disposed flow paths, e.g. channels 17, for the uniform distribution of the reaction medium through the electrode surface. Projecting elements, e.g. webs 16 between the channels 17, form the electrical contact with the adjacent electrode 2 and 3. A distribution structure 12 on the anode side of the BPP 7 serves to distribute the fuel over the surface of the anode 2, while a distribution structure 13 on the cathode side serves to distribute the oxidizing agent over the surface of the cathode 3. The distribution structures 12, 13 are connected to the through-holes of the corresponding media supply lines 8, 10 and media removal lines 9, 11. These connections are identified as 14 and 15 in FIG. 1. The region of the surface of the bipolar plate that via the contact webs is in electrical contact, and via the media distribution structure is in mass exchange, with the adjoining electrode is hereinafter termed the active surface. The through-holes 8, 9, 10, 11 lie outside the active surface. The distribution structures 12, 13 illustrated in FIG. 1 should be understood only by way of example, and should not be understood as restricting the invention to a specific distribution structure or giving preference to a specific distribution structure. In addition to this type of construction with media supply and removal lines that are formed by aligned through-holes 8, 9, 10, 11 in the stack components (internal manifolding), stacks are also known with media supply and removal lines disposed outside the BPP and MEA surfaces (external manifolding). In this case the media supply and removal takes place via distribution and collection lines mounted laterally on the stack, which are connected to the respective media distribution structures on the plate surfaces. Leakage and mixing of the various reaction media must be prevented. To this end, on the one hand the anode side of each BPP 7 is sealed against the through-holes 10, 11 for the oxidizing agent transport, and on the other hand the cathode side is sealed against the through-holes 8, 9 for the fuel transport. Also, the distribution structures 12, 13 incorporated into the plate surfaces are enclosed by seals 18 so that leakage of the reaction media at the interfaces between the BPP and MEA is prevented.

Heat is released during the electrode reactions. The heat must be dissipated in order to prevent heating of the cells. For this purpose a coolant, e.g. deionized water or a thermal oil, is passed through the stack. In a known implementation (FIG. 2) of a cooled stack, instead of a one-piece bipolar plate 7 a pair of two terminal plates 7a, 7b, which surround a coolant distribution structure, is disposed between two membrane-electrode assemblies 5, 5′. The surfaces of the terminal plates 7a, 7b that abut one another are hereinafter termed cooling surfaces. The coolant distribution structure is constructed similarly to the distribution structures 12, 13 for the reaction media and contain channels 19 incorporated in at least one of the cooling surfaces, through which the coolant flows, and webs 20 or similar projecting elements bounding the channels, that form the electrical contact between the adjacent cooling surfaces and thus permit the flow of current from the active surface of the terminal plate 7a to the active surface of the terminal plate 7b.

For the supply and removal of the coolant, further transport paths passing through the stack have to be provided, and the transport paths of the coolant and of the reaction media must be sealed against one another. In addition, seals 21 are necessary between the cooling surfaces of the terminal plates 7a, 7b, in order to prevent leakage of the coolant from the coolant distribution structure. The seal 21 is accommodated by mutually co-operating sealing grooves 22a, 22b incorporated in the cooling surfaces of the terminal plates 7a, 7b. As illustrated in FIGS. 1 and 2, the channel structure 12 for the two-dimensional distribution of the fuel is incorporated into the surface of the anode-side terminal plate 7b facing towards the anode 2′ of the MEA 5′. The channel structure 13 for the two-dimensional distribution of the oxidizing agent is formed in the surface of the cathode-side terminal plate 7 a facing towards the cathode 3 of the MEA 5. In an alternative variant the surfaces of the terminal plates facing towards the electrodes are flat, and the reaction media distribution structure is incorporated in the surface of the respective electrode facing towards the terminal plate.

In order to reduce the number of individual components for a stack and to facilitate the installation, it is desirable to combine individual components into prefabricated structural groups (modules). For example, published, European patent application EP 1 009 051 A discloses a composite of an anode-side terminal plate and a cathode-side terminal plate. The terminal plates are formed of a corrosion-resistant, electrically conducting material, for example of metal, graphite or a composite material of a plastics and carbon or graphite. Channels for the flow of a coolant are incorporated in the cooling surfaces of the terminal plates. The channels are bounded by projecting material webs. The surfaces of the webs on the cooling surface of the first terminal plate abut against the surfaces of the webs on the cooling surface of the second terminal plate. These contact surfaces form the electrical contact between the terminal plates.

The anode-side terminal plate and the cathode-side terminal plate are electrically connected to one another by an electrically conducting bonding agent. The bonding agent contains dispersed corrosion-resistant conducting particles, for example of silver, gold, platinum, nickel or graphite, in a polymer matrix, for example an epoxy resin. The mass proportion of the conducting particles in the bonding agent is 20 to 40%. The electrical resistivity of the bonding agent must not exceed 1 Ohm*cm.

In an alternative variant a conducting two-dimensional element, for example a metal sheet, is placed between the cooling surfaces of the terminal plates and is connected by a conducting bonding agent to the cooling surfaces. The metal sheet separates the cooling channels on the cooling surface of the first terminal plate from the cooling channels on the cooling surface of the second terminal plate, or alternatively the metal sheet is provided with perforations that connect the cooling channels on the cooling surface of the first terminal plate to those on the cooling surface of the second terminal plate.

All concepts presented in published, European patent application EP 1 009 051 A are connected with the use of a conducting bonding agent. The bonding agent must be applied everywhere where electrical contact between the cooling surfaces is to be produced, thus for example on the surfaces of all webs in the coolant distribution structure. Sealing beads, which can also be fabricated from a non-conducting material, for example silicone, are applied only on the outer circumference of the cooling surfaces and on the edges of the through-holes.

The webs on the cooling surfaces that are coated with the bonding agent and form the electrical contact with the neighboring terminal plate are directly adjacent to the channels through which the coolant flows. The bonding agent therefore inevitably comes into contact with the coolant. This situation gives rise to a further essential requirement on the bonding agent, namely that it must be resistant to the heated coolant. In this connection it should be noted that antifreeze agents and/or other auxiliary substances are added to the coolant for certain applications, and the bonding agent must likewise be insensitive to these agents. For this reason and also for economic reasons it is desirable to avoid the large-scale use of electrically-conducting bonding agents in the cooling plate composite.

### SUMMARY OF THE INVENTION

It is accordingly an object of the invention to provide a cooling plate module for a fuel cell stack which overcomes the above-mentioned disadvantages of the prior art devices and methods of this general type.

The object of the present invention is to provide a cooling plate module containing an anode-side terminal plate and a cathode-side terminal plate whose abutting surfaces (cooling surfaces) are in electrical contact with one another and tightly enclose a coolant distribution structure. A cohesion of the terminal plates is achieved by a bonding agent that does not have to fulfil particular requirements as regards electrical conductivity.

A further object of the invention is to avoid contact between the bonding agent and the coolant in such a cooling plate module.

The object is achieved by a module containing an anode-side and a cathode-side terminal plate, whose mutually facing surfaces enclose as cooling surfaces a coolant distribution structure that is enclosed by a seal and is outwardly sealed. A bonding agent is applied to at least one of the cooling surfaces outside the region enclosed by the seal, which bonding agent fixes the terminal plates to one another in situ and joins them to one another.

The bonding agent is according to the invention applied exclusively to those regions of the cooling surfaces that are located outside the coolant distribution structure. The surfaces of the projecting elements of the coolant distribution structure, for example as webs, remain free of bonding agent, so that here a direct electrical contact between the abutting cooling surfaces is possible.

Since the bonding agent is not applied in the region of the cooling surface that is directly required for the electrical contact between the active surfaces of the terminal plates, the bonding agent itself need not be electrically conducting. The bonding agent does not come into contact with the coolant, since the bonding surfaces lie outside the coolant distribution structure enclosed by the seal. For this reason the resistance of the bonding agent to the coolant and auxiliary substances possibly added to the coolant is not critical.

The bonding agent itself also does not have to fulfil a sealing function, for in the cooling plate module according to the invention the interface between the cooling surfaces is sealed by a seal. The seal surrounds the region of the cooling surface through which the cooling channels pass and thus prevents leakage of the coolant.

Other features which are considered as characteristic for the invention are set forth in the appended claims.

Although the invention is illustrated and described herein as embodied in a cooling plate module for a fuel cell stack, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a diagrammatic, exploded perspective view of a fuel cell stack according to the prior art;

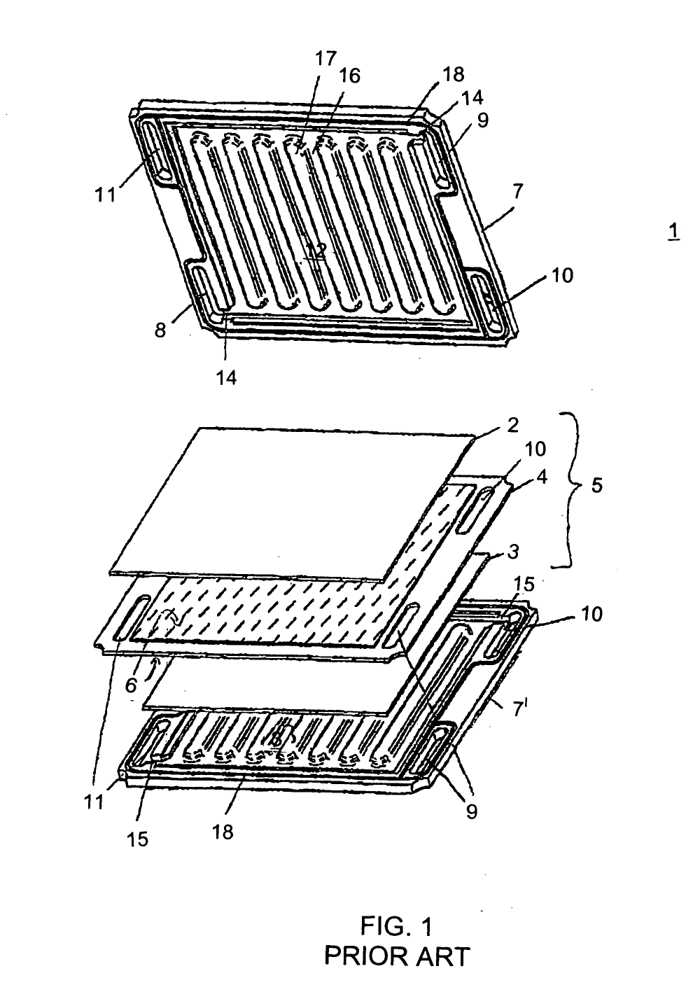

FIG. 2 is a diagrammatic, cross-sectional view through the fuel cell stack with a coolant distribution structure between the terminal plates;

FIG. 3 is a diagrammatic, plan view of a cooling surface of a terminal plate with a coolant distribution structure, seals and identification of the bonding surfaces according to the invention; and

FIG. 4 is a diagrammatic, sectional view through the fuel cell stack with cooling plate modules according to the invention.

### DESCRIPTION OF THE PREFERRED EMBODIMENTS

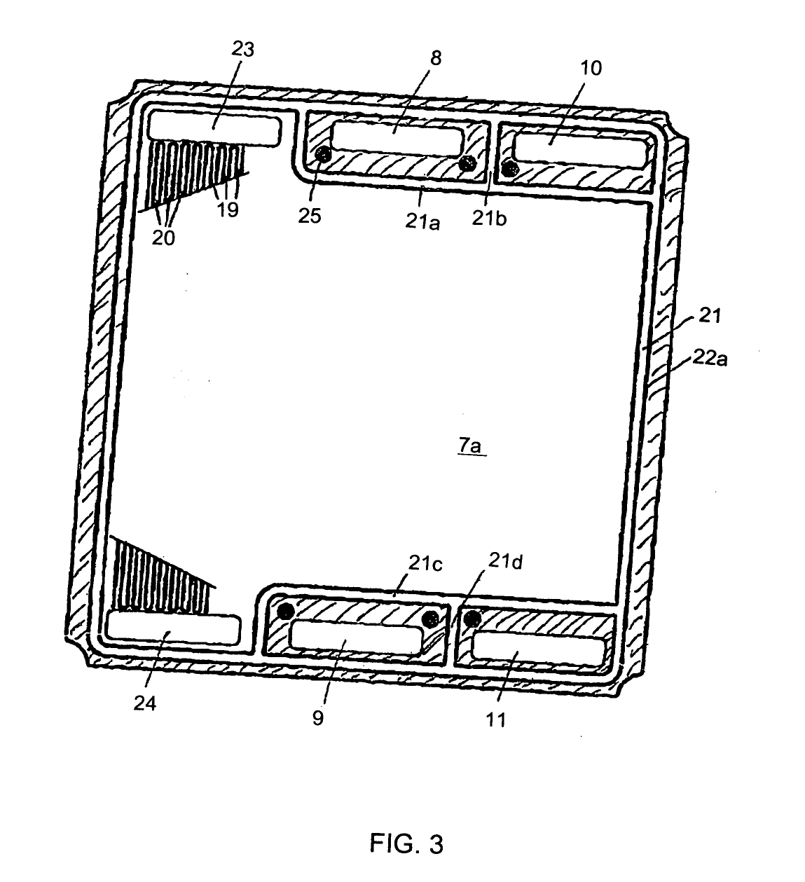

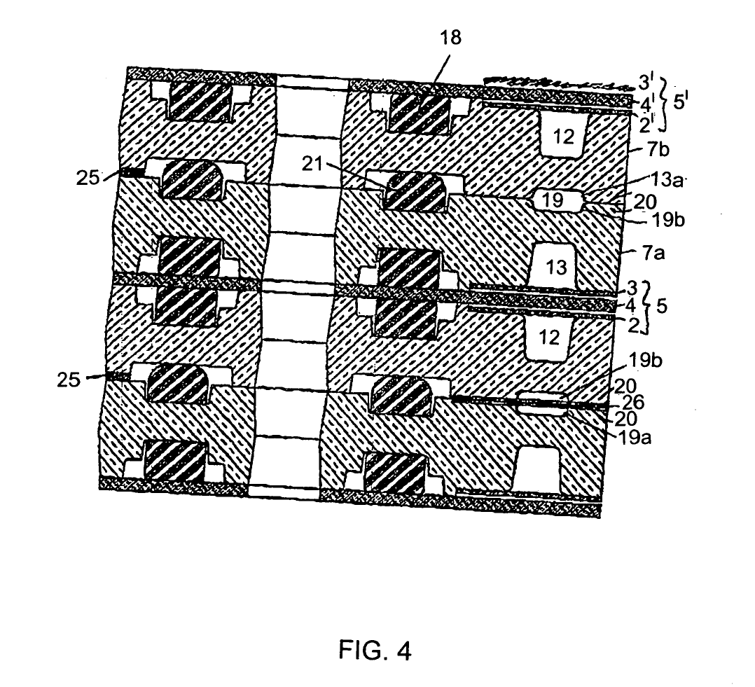

Referring now to the figures of the drawing in detail and first, particularly, to FIGS. 3 and 4 thereof, there is shown a cooling plate module according to the invention. The cooling plate module contains a cathode-side terminal plate 7a and an anode-side terminal plate 7b, whose mutually abutting surfaces enclose as cooling surfaces a coolant distribution structure, as well as a seal 21 for sealing the interface between the cooling surfaces of the terminal plates. At least one of the cooling surfaces is provided with channels 19 for the two-dimensional distribution of a coolant.

FIG. 3 is a plan view of the cooling surface of the terminal plate 7a with an indicated coolant distribution structure and the associated seals. In stacks with internal media supply and removal (internal manifolding) the supply of the coolant takes place via a through-hole 23 and the removal of coolant takes place via a through-hole 24. All MEAs and terminal plates of a stack have in each case such through-holes at the same position. When stacking the MEAs and terminal plates to form a stack the through-holes coincide, transport paths passing through the stack thereby being formed. The coolant flows from the supply line via the through-hole 23 into the cooling channels 19 on the cooling surface, flows through the coolant channels 19, and flows from the cooling channels 19 via the through-hole 24 into the coolant removal line.

In FIG. 3 the exact course of the cooling channels was omitted for the sake of clarity, since it is not relevant to the present invention. A large number of suitable channel structures (flow fields) are known to the person skilled in the art, and the invention is not restricted to a specific channel structure. The channel structures for the distribution of the coolant are formed for example of a plurality of parallel channels that are fed by a common supply line and terminate in a common collection line, or are formed of one or more meandering channels.

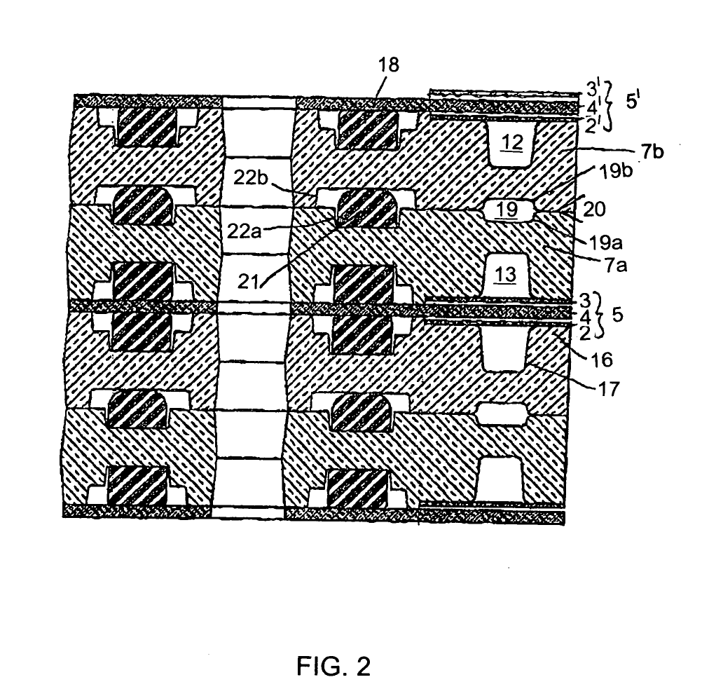

Often it is sufficient if one of the two mutually abutting cooling surfaces is provided with a channel structure. The other, flat cooling surface then covers the channels on the first cooling surface. In another variant of the cooling plate composite according to the invention (FIG. 2) the cooling surfaces of both terminal plates 7a, 7b are each provided with a channel structure 19a, 19b, in which the channel structure 19b on the cooling surface of the second terminal plate 7b is the mirror image of the channel structure 19a on the first terminal plate 7a. When the cooling surfaces are laid on top of one another the channels in the cooling surface of the first terminal plate are thus complemented by the channels of the cooling surface of the second terminal plate to form a common coolant distribution structure surrounded by the seal 21.

In the internal manifold type of construction each terminal plate furthermore has through-holes for the fuel supply 8, fuel removal 9, oxidizing agent supply 10 and oxidizing agent removal 11 of the stack. These have no connection to the coolant distribution structure.

The seal 21 is located between the cathode-side terminal plate 7a and the anode-side terminal plate 7b. As FIG. 3 shows, the seal 21 lying in a sealing groove 22 a encloses the coolant distribution structure including the through-holes 23 and 24, connected to the cooling channels, for the coolant supply and removal. The seal 21 seals the interface between the cooling surfaces of the two terminal plates 7a, 7b and thus prevents leakage of the coolant. The region of the cooling surface that is located outside the seal 21 is hereinafter termed the periphery.

The through-holes 8, 9, 10, 11 are, as shown in FIG. 3, surrounded by sealing strands 21a, 21b, 21c, 21d branching off from the seal 21, so that no penetration of the reaction media into the coolant distribution structure is possible. Alternatively, the through-holes 8, 9, 10, 11 can be enclosed by separate seals.

The seals on the cooling surfaces may be configured as flat seals, as profiled seals or as O-rings. As is shown in FIG. 2, grooves 22a, 22b that accommodate the seals are provided in the cooling surfaces of the terminal plates 7a, 7b. The cooling surface of the second terminal plate 7b, which is combined with the terminal plate 7a shown in FIG. 3 to form the cooling plate module according to the invention, contains at the corresponding positions complementary sealing grooves 22b that co-operate with the sealing grooves 22a on the cooling surface of the first terminal plate 7a and surround the seals 21.

Although FIG. 3 shows by way of example a terminal plate with through-holes for the media supply and removal, i.e. for a construction with internal manifolding, the invention is not restricted to this stack configuration; it can also be used for stacks with external media supply and removal (external manifolding). The decisive factor as regards the invention is only that the bonding agent is applied to the cooling surface outside the coolant distribution structure surrounded by the seal 21.

The terminal plates that form the bipolar cooling plate module according to the invention are formed of an electrically conducting corrosion-resistant impermeable material, for example graphite, metal or a composite material of plastics and conducting particles. Metals that are not sufficiently corrosion-resistant must be alloyed and/or provided with a corrosion-resistant electrically conducting coating, for example of a noble metal, to reduce corrosion.

Graphite in its various forms may be used. Terminal plates can be fabricated from monolithic blocks of synthetic graphite by cutting and machining. Alternatively, suitably structured sheets of pressed expanded graphite can be used as terminal plates.

The production of terminal plates from composite materials of plastics and conducting particles is particularly advantageous, since forming processes known from plastics technology, such as injection molding—possibly with some modifications—can be used in this case. In conventional insulating plastics such as polypropylene, polyvinylideno fluoride, vinyl esters or phenol resins or epoxy resins, electrical conductivity can be achieved by adding electrically conducting particles, for example particles of synthetic or natural graphite, graphite expandate, carbon black, carbon fibers, metal chips, metal fibers or combinations of several of these types of conducting particles. The concentration of the conducting particles must be sufficiently high in order to exceed the percolation threshold, so that a continuous network of electrical conducting pathways is formed in the plastics matrix. The high mass fraction of the conducting particles (more than 60%) required for this purpose reduces the flowability of the plastics, however, so that appropriate measures must be adopted in its processing by known plastics processing methods. These measures are, however, known to the person skilled in the art. Alternatively terminal plates may be formed from a composite material of plastics and conducting particles in a suitably structured compression mould.

Suitable sealing materials are for example thermoplastic elastomers (TPE), thermoplastic urethane (TPU), liquid silicone rubber (LSR), ethylene/propylene diene elastomer (EPDM), polytetrafluoroethylene (PTFE) or fluoroelastomers or silicones.

The seals 18 and 21 may be formed as flat seals, as profiled seals or as O-rings The seal is prefabricated for example in a known manner from the sealing material and is inserted or bonded into the sealing groove of one of the two terminal plates to be joined. Processes for the production of such seals are known, for example flat seals are stamped out or cut out, for example jet cut, from a two-dimensional semi-finished product formed from the sealing material. Techniques for producing O-rings or profiled seals are also known to the person skilled in the art.

Alternatively the sealing material can be applied directly to the sealing grooves on the cooling surface of one of the terminal plates of the cooling plate module according to the invention, for example by a metering robot or by injection molding.

According to the invention the bonding agent does not have to meet special requirements as regards conductivity and resistance to the coolant. Accordingly any bonding agent that is suitable for forming a bond between the two terminal plates may be used to produce the cooling plate module according to the invention. Various commercially obtainable bonding agents may be used. For example, bonding agents based on epoxy resin or cyanoacrylate have proved suitable for joining terminal plates of plastics-graphite composite materials.

Exclusively those-regions of the cooling surface that lie outside the coolant distribution structure surrounded by the seal 21, i.e. that lie on the periphery of the cooling surface, serve as cooling surfaces (see FIG. 3). These regions are identified by hatched lines in FIG. 3. For example the bonding agent may be applied in the vicinity of the through-holes 8, 9, 10, 11 that lie outside the region enclosed by the seal 21, or may be applied at the outermost edge of the cooling surface.

The decisive factor as regards the invention is that the bonding agent, which is non-conducting or only limitedly conducting, is not applied to those parts of the cooling surface that lie directly on the rear side of the active surface, for the current flow from the active surface of the first terminal plate to the active surface of the next terminal plate basically follows the shortest path through the terminal plate. Accordingly the region of the cooling surface that lies directly on the rear side of the active surface is required for the electrical contact with the second terminal plate. Normally the coolant distribution structure surrounded by the seal is disposed so that it is located on the rear side of the active surface. The periphery of the cooling surface on the other hand lies outside the region required for the direct current flow and is thus available as bonding surface.

Within this surface the bonding agent can be applied in a punctiform manner or over an area thereof. Some points at which the bonding agent 25 has been applied outside the active surface are identified by way of example in FIG. 3.

Punctiform application is preferred for economic reasons as long as an adequate bonding effect is thereby achieved. The bonding agent is applied either to one of the two surfaces to be joined together, or to both surfaces.

In order to prevent the bonding agent layer acting as a spacer between the cooling surfaces and thereby adversely affecting the electrical contact thereof, it is advantageous to deepen somewhat the surface regions provided for the application of the bonding agent relative to the regions that are in electrical contact. This situation is illustrated in FIG. 4. In the region 25 where the bonding agent is applied the surface of the terminal plate 7b on the cooling surface side is set back somewhat (deepened) compared to the surface regions that are not provided for the bonding agent application.

The depressions may for example be cut into the cooling surfaces of the already-structured terminal plates, or corresponding depressions are already provided directly during the fabrication of the terminal plates in the injection mould or compression mold. The depressions should be configured so that they can receive a bonding agent layer with strength sufficient for the adhesion of the bonding surfaces to one another. On the other hand they must not be so deep that the introduced bonding agent layer has no contact with the bonding surface of the second terminal plate, and/or an unnecessarily thick bonding agent layer would be necessary in order to join the bonding surfaces. The bonding agent is hardened under pressure, if necessary at elevated temperature. To this end the cooling plate module is placed in a press and subjected to such a pressure that the seal is compressed to such an extent that a sealing effect is achieved. For seals of TPE this pressure is for example 0.5 to 8 MPa. A more efficient procedure for the hardening is to place a plurality of cooling plate modules stacked above one another into the press.

The cooling plate modules according to the invention are ready for installation and can be combined with membrane-electrode assemblies in a known manner to form fuel cell stacks.

The function of the bonding agent is basically to fix the two terminal plates to one another in situ and to combine them into a structural group in order thereby to facilitate the installation of the stack. The bonded joint itself need not be tight, since according to the invention a seal is provided between the cooling surfaces. Accordingly it is also not absolutely necessary for the bonding agent to be persistent. A temporary bonding action during the installation, i.e. until the stack is clamped, is in principle sufficient. Following this the bonding action is no longer absolutely necessary, since the components of the stack are now adequately fixed in situ by the clamping. According to the invention bonding agents may therefore also be used whose effectiveness is time-limited, but which lasts at least during the duration of the installation of the stack. The installation of a stack using cooling plate modules that are held together with an only temporarily-acting bonding agent substantially contains the following basic steps:

a) provision of anode-side and cathode-side terminal plates, seals and membrane-electrode assemblies in the desired number;

b) introduction of the seals 21 between the cooling surfaces of the terminal plates;

c) production of cooling plate modules by joining the cooling surfaces of the terminal plates by use of a bonding agent that is applied to the periphery of at least one of the cooling surfaces to be joined;

d) alternate stacking of cooling plate modules and MEAs on top of one another, so that in each case the anode plate of a cooling plate module is followed by the anode of an MEA and the cathode plate of a cooling plate module is followed by the cathode of an MEA, in which the interfaces between MEAs and terminal plates should be sealed in a suitable manner known to the person skilled in the art;

e) attachment of current collectors before the first and after the last MEA;

f) if necessary, attachment of external manifolds and other additional components; and

g) clamping of the stack between end plates, wherein the bonding action of the bonding agent basically lasts only for the duration of the installation procedure.

The invention is not restricted to the use of a specific coolant. Because the bonding agent and coolant do not come into contact with one another, the choice of the coolant needs to be governed only by the desired operating temperature of the fuel cell stack. Coolants that are typically used are water, preferably deionized water, optionally with the addition of an antifreeze agent, or thermal oil.

If necessary, in order to reduce contact resistance between the contact elements of the cooling surfaces a two-dimensional electrically conducting element may be inserted that contains for example a metal sheet, a metal foil or graphite foil, or a felt, fleece, laid fabric or paper of carbon or graphite fibers. This situation is shown in the lower part of FIG. 4. The two-dimensional conducting element 26 extends at most only over the region of the cooling surfaces enclosed by the seal 21, in which are located the webs 20 necessary for the contact between the cooling surfaces. If both cooling surfaces are provided with channels 19a, 19b, then this two-dimensional conducting element separates the cooling channels on the cooling surface of the first terminal plate from the cooling channels on the cooling surface of the second terminal plate. Alternatively a two-dimensional conducting element with perforations that join the cooling channels on the cooling surface of the first terminal plate to those on the cooling surface of the second terminal plate may be used. This variant is, however, less preferred on account of the greater installation expenditure, since the perforations have to be positioned exactly so as to match the channels.

Graphite foil is particularly suitable for improving the electrical contact between the coolant distribution structures, since this material adapts extremely well to the adjacent surfaces and can compensate for any possible deviations from parallelism of the terminal plates.

Examples of implementation are now presented.

3 mm-thick injection-molded terminal plates of a graphite-thermoplastics composite material were used. The terminal plates 7a were provided with a cathode-side oxidizing agent distribution structure, and on the cooling surface with a coolant distribution structure. The terminal plates 7b were provided with an anode-side fuel distribution structure, and on the cooling surface with a coolant distribution structure that was a mirror image of the coolant distribution structure on the cooling surface of the terminal plate 7a.

The seals 21 are formed of ethylene-propylene diene elastomer and were bonded into the sealing groove.

Two cooling plate modules were produced, one of which is formed with a two-dimensional element 26 of graphite foil inserted between the cooling surfaces and that extended over the region of the cooling surfaces enclosed by the seal 21.

Before the production of the modules the volume resistance (i.e. the resistance perpendicular to the plate surface) and the parallelism (difference between the largest and smallest thickness measurement values at four measurement points distributed uniformly over the plate) were measured.

An epoxy resin bonding agent was used to join the cooling surfaces. The bonding agent was applied as illustrated in FIG. 3. The bonded joint was hardened by subjecting the cooling plate modules for 1 hour at room temperature to a pressure of 1.3 MPa.

The parallelism and volume resistance of the composites produced in this way were measured. The results are shown in the following Table 1.

TABLE 1
Characterization Of The Terminal Plates And
Cooling Plate Modules Produced Therefrom

| | Cooling Plate | Cooling Plate |
|---|---|---|
| | Module with | Module without |
| | Graphite Foil | Graphite Foil |
| Volume resistance of the | 10.9 | 11.6 |
| plate 7a/mΩ*cm² | | |
| Volume resistance of the | 11.6 | 11.3 |
| plate 7b/mΩ*cm² | | |
| Sum of the volume | 22.5 | 22.9 |
| resistance of the | | |
| cooling plates 7a and | | |
| 7b/mΩ*cm² | | |
| Volume resistance of the | 20.2 | 30.4 |
| cooling plate module/ | | |
| mΩ*cm² | | |
| Contact resistance/ | −2.3 | 7.5 |
| mΩ*cm² | | |
| Parallelism of the | 0.02 | 0.1 |
| terminal plate 7a/mm | | |
| Parallelism of the | 0.08 | 0.09 |
| terminal plate 7b/mm | | |
| Parallelism of the | 0.07 | 0.07 |
| cooling plate module/mm | | |

The measured volume resistivities of the individual components contain contributions from the two terminal-plate/measurement-electrode interfaces, which are correspondingly also included in the sum. If the transition resistance between the joined terminal plates is less than twice the transition resistance of the terminal-plate/measurement-electrode, then the volume resistance of the composite is less than the sum of the volume resistivities of the components. On account of its ability to adapt to the contact surfaces, the inserted graphite foil reduced the volume resistance of the composite to such an extent that it was less than the sum of the volume resistances of both components. As a consequence of a high transition resistance at the contact points between the cooling surfaces, the volume resistance of the module without inserted graphite foil was, however, higher than the sum of the resistances of the individual terminal plates. In this case possibly further improvements can be achieved by the proposed deepening of the bonding surfaces.

The parallelism of the modules was always better than the sum of the parallelisms of the individual terminal plates. Obviously the deviations of the individual terminal plates from parallelism are at least partly compensated in the composite. The intermediately-placed graphite foil is therefore not absolutely necessary in this case to compensate possible deviations from parallelism of the plates.

This application claims the priority, under 35 U.S.C. §119, of European patent application EP 04 025 726.3, filed Oct. 29, 2004; the entire disclosure of the prior application is herewith incorporated by reference.

We claim:

1. A cooling plate module for a fuel cell stack, the cooling plate module comprising:
a cathode-side terminal plate;
an anode-side terminal plate, said cathode-side terminal plate and said anode-side terminal plate having mutually abutting surfaces tightly surrounding and defining, as cooling surfaces, a coolant distribution structure of channels having a coolant flowing therethrough, said mutually abutting surfaces being in direct electrical contact with one another in a region of said coolant distribution structure of channels;
a seal enclosing said coolant distribution structure of channels; and
a bonding agent applied to at least one of said cooling surfaces outside a region enclosed by said seal, said bonding agent joining said cathode-side terminal plate and said anode-side terminal plate to one another.

2. The cooling plate module according to claim 1, wherein said bonding agent is electrically non-conducting.

3. The cooling plate module according to claim 1, wherein said bonding agent is selected from the group consisting of a cyanoacrylate and epoxy resin.

4. The cooling plate module according to claim 1, wherein said channels forming said coolant distribution structure are formed only in one cooling surface of one of said cathode-side terminal plate and said anode-side terminal plate, said channels being covered by a flat cooling surface of the other of said cathode-side terminal plate and said anode-side terminal plate.

5. The cooling plate module according to claim 1, wherein said mutually abutting cooling surfaces of both of said cathode-side terminal plate and said anode-side terminal plate define said channels of said coolant distribution structure, said channels of said coolant distribution structure on a cooling surface-of said cathode-side terminal plate is a mirror image of said channels of said coolant distribution structure on a cooling surface of said anode-side terminal plate.

6. The cooling plate module according to claim 1, further comprising a two-dimensional electrically conducting element disposed between said cooling surfaces, said element extending only within said region of said cooling surfaces enclosed by said seal.

7. The cooling plate module according to claim 6, wherein said two-dimensional conducting element is formed of a material selected from the group consisting of graphite foil, fleece, felt, nonwoven fabric, laid fabric, graphite paper and carbon fiber paper.

8. The cooling plate module according to claim 1, wherein at least one of said cooling surfaces have depressions formed therein for receiving said bonding agent, outside of said region enclosed by said seal.

9. A process for installing a fuel cell stack, which comprises the steps of:
providing cathode-side and anode-side terminal plates, seals, and membrane-electrode assemblies in a desired number;
inserting the seals between cooling surfaces of the terminal plates;
producing cooling plate modules by joining the cooling surfaces of the terminal plates using a bonding agent applied to at least one of the cooling surfaces to be joined outside a coolant distribution structure surrounded by the seals;
alternatingly stacking of the cooling plate modules and membrane-electrode assemblies on top of one another, so that in each case an anode plate of a cooling plate module is followed by an anode of a membrane-electrode assembly, and the cathode plate of a cooling plate module is followed by a cathode of a membrane-electrode assembly, in which interfaces between the membrane-electrode assemblies and the terminal plates are sealed;
attaching current collectors before a first and after a last membrane-electrode assembly;
attaching external media supply and removal lines, if no internal media supply and removal lines are provided;
clamping of the fuel cell stack between end plates; and
setting an effectiveness of the bonding agent for lasting only for a duration of an installation procedure.

10. The process according to claim 9, which further comprises inserting a two-dimensional electrically conducting element between the cooling surfaces, the two-dimensional electrically conducting element extending only within a region of the cooling surfaces enclosed by a respective seal.

11. The process according to claim 10, which further comprises forming the two-dimensional conducting element to contain a material item selected from the group consisting of a graphite foil, fleece, felt, nonwoven fabric, laid fabric, graphite paper and carbon fiber paper.
